(19) United States
(12) Patent Application Publication
(10) Pub. No.: US 2017/0247785 A1
(43) Pub. Date: Aug. 31, 2017

(54) REACTIVE DEPOSITION SYSTEMS AND ASSOCIATED METHODS

(71) Applicant: WASHINGTON STATE UNIVERSITY, Pullman, WA (US)

(72) Inventors: Amit BANDYOPADHYAY, Pullman, WA (US); Himanshu SAHASRABUDHE, Pullman, WA (US); Susmita BOSE, Pullman, WA (US)

(21) Appl. No.: 15/517,232

(22) PCT Filed: Oct. 13, 2015
(86) PCT No.: PCT/US15/55218

§ 371 Date: Apr. 6, 2017

Related U.S. Application Data
(60) Provisional application No. 62/063,189, filed on Oct. 13, 2014.

(51) Int. Cl. C23C 8/24; B33Y 40/00; B33Y 10/00; B23K 26/342; B23K 26/70

(52) U.S. Cl. CPC C23C 8/24; B23K 26/342; B23K 26/70; B33Y 10/00; B33Y 40/00; B23K 2203/14

(57) ABSTRACT

Techniques for reactive deposition are disclosed herein. In one embodiment, a method includes providing laser energy into a deposition environment, the laser energy having a focal point and introducing a first precursor material and a second precursor material into the deposition environment at or near the focal point of the provided laser energy, thereby causing the first and second precursor materials to melt and react to form a composite material different than both the first and second precursor materials. The method also includes allowing the formed composite to solidify by moving the focal point of the provided laser energy away from the melted first and second precursor materials.

### BACKGROUND

Ceramic or other types of coatings are widely used to protect structures and devices from thermal, chemical, or mechanical damages. For example, TiN—TiC—Al₂O₃, TiAlN, and TiBN ceramic coatings have been widely used on dies, cutting tools, and other items. These coatings have high hardness, great wear resistance, and excellent thermal stability. Fabrication techniques of such coatings typically include chemical vapor deposition (“CVD”), physical vapor deposition (“PVD”), or thermal spray techniques.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Conventional deposition techniques have various drawbacks when applied to deposit ceramic or other types of hard coatings on a substrate. For example, CVD is a gas based process in which gaseous precursor reactants react to form a solid coating on a substrate surface. CVD, however, can only deposit a relatively thin layer on the substrate surface. In contrast, PVD is a technique in which vaporized coating materials condense onto a substrate surface without chemical reactions. However, coatings formed using PVD may be uneven over sections of a substrate surface especially when the substrate has complex geometries. Plasma spraying, wire arc spraying, high velocity oxy-fuel are some thermal spraying techniques in which coating materials are heated to a molten or semi-molten state before being sprayed onto a substrate surface. Compared to CVD and PVD, thermal spray techniques can have higher deposition rates. However, such deposition techniques lack flexibility in simultaneous composition and feature control.

Several embodiments of the disclosed technology are directed to additive deposition techniques (sometimes referred to as 3D printing, layered manufacturing, solid freeform fabrication, or rapid prototyping) in which precursor materials react in situ during deposition to form a bulk product of a multi-component composite in a layer-by-layer, section-by-section, or other suitable basis. For example, multiple precursor materials (e.g., metals, salts, or ceramics) can be simultaneously fed into a focal point of an energy stream (e.g., laser, microwave, electron beam, etc.). The energy stream then causes the precursor materials to react to form a layer or a section of a layer of a product. Repetitions or continuation of such feeding, reacting, and forming operations can form successive sections and/or layers of the final product.

During deposition of a layer or section of a layer, various operating parameters can be adjusted to achieve a desired composition, physical parameter (e.g., hardness), sectional composition gradient, or other desired characteristics of the final product on the same or different layers or sections of the product. For instance, in one embodiment, a deposition environment can be adjusted to feed a gaseous precursor material (e.g., nitrogen, oxygen, or hydrogen) into a deposition chamber. The gaseous precursor material can then react with other precursor materials to form a composite containing nitrogen, oxygen, or hydrogen. In another embodiment, one or more feed rates of the precursor materials can be adjusted to achieve a target composition or sectional composition gradient. In further embodiments, one or more of a laser power, scanning speed, or other operating parameters of the laser can be adjusted to achieve the target characteristics of the final product.

Several embodiments of the disclosed technology can efficiently and cost effectively produce bulk final products with desired profiles of structure, composition, crystallinity, and/or other physical properties. In particular, several embodiments of the disclosed technology are suitable for producing bulk products of high melting point ceramics. Unlike CVD, PVD, or thermal spraying techniques, several embodiments of the disclosed technology are more flexible in achieving the desired profiles of properties. For instance, thermal spraying can only deposit a melted initial composition of a coating material onto a substrate. In contrast, several embodiments of the disclosed technology can allow great flexibility in compositional control during deposition by varying, for example, feed rates or feed ratio of precursor materials to form a product having a desired compositions within a layer of the product, over multiple layers of the product, or in other suitable basis.

### BRIEF DESCRIPTION OF THE DRAWINGS

FIG. 1 is a schematic diagram of a reactive deposition system in accordance with embodiments of the disclosed technology.

FIG. 2 is a block diagram showing computing system software components suitable for the reactive deposition system of FIG. 1 in accordance with embodiments of the disclosed technology.

FIG. 3 is a block diagram showing software modules suitable for the process component of FIG. 2 in accordance with embodiments of the disclosed technology.

FIGS. 4A-4D are flowcharts showing methods for reactive deposition of a composite material in accordance with embodiments of the disclosed technology.

FIGS. 5A-5C are example scanning electron microscope (“SEM”) images of a silicon (Si) coating on commercially pure (Cp) titanium (Ti) samples at a 60-time magnification for 0%, 10%, and 25% of Si, respectively, in accordance with embodiments of the disclosed technology.

FIGS. 6A-6C are example SEM images of a silicon (Si) coating on Cp-Ti samples at a 1000-time magnification for 0%, 10%, and 25% of Si, respectively, in accordance with embodiments of the disclosed technology.

FIGS. 6A-6C are example SEM images of a silicon (Si) coating on Cp-Ti samples at a 2000-time magnification for 0%, 10%, and 25% of Si, respectively, in accordance with embodiments of the disclosed technology.

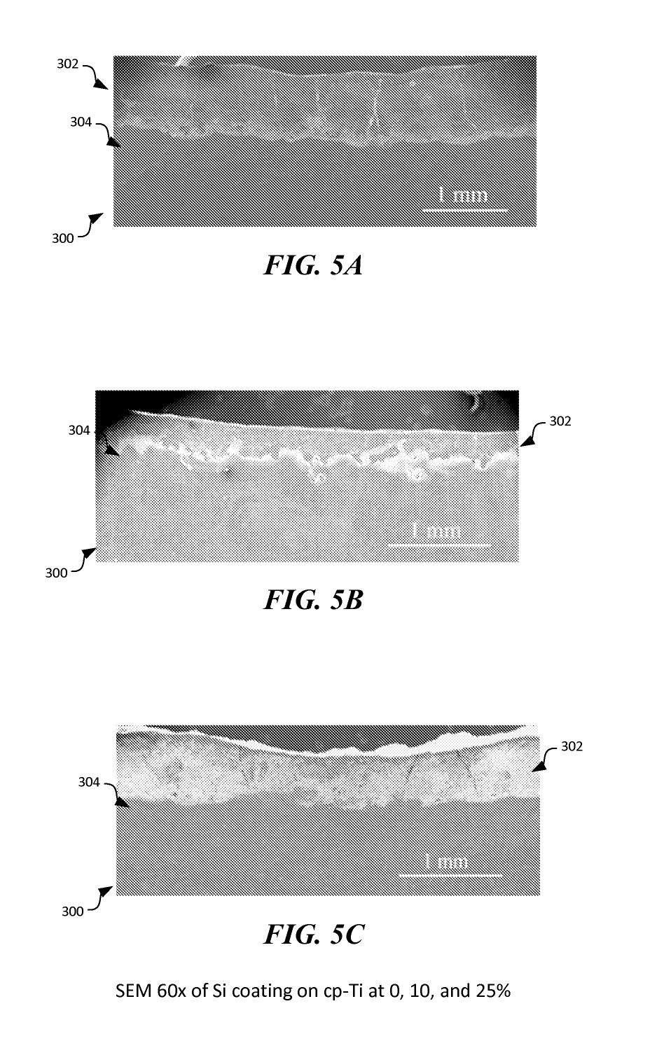

FIGS. 5A-5D are schematic diagrams illustrating an example interconnect device under various strain conditions in accordance with embodiments of the disclosed technology.

FIG. 8A is an example SEM image of a Cp-Ti substrate sample at a 1000-time magnification.

FIG. 8B is an example SEM image of an aluminum (Al) ball after wear testing on a 0% Si sample for 1000 meter distance in distilled water (“DI”) at room temperature.

FIG. 9A is an example X-ray Diffraction (“XRD”) graph showing peaks associated with various Si coatings on Cp-Ti samples.

FIG. 9B is an example graph showing hardness depth profile of Ti—Si—N coatings on Cp-Ti samples.

FIG. 9C is an example graph showing wear rate of various Cp-Ti samples with Si coatings in DI water after 1000 meter distance at room temperature.

FIG. 9D is an example XRD graph showing peaks of various Ti—Si coatings on Cp-Ti samples.

FIG. 10A is an example SEM image of a nitride coating formed on Cp-Ti in accordance with embodiments of the disclosed technology.

FIG. 10B is an example SEM image of a nitride coating formed on Cp-Ti with dendritic and secondary phases in accordance with embodiments of the disclosed technology.

FIG. 10C are example SEM images of nitride coatings formed on Cp-Ti by varying laser power and/or scanning speed during deposition in accordance with embodiments of the disclosed technology.

FIG. 11 is an example XRD graph showing peaks of various nitride coatings on Cp-Ti samples.

FIG. 12 is an example XRD graph showing peaks of various Zr—B—N coatings on Cp-Ti samples.

### DETAILED DESCRIPTION

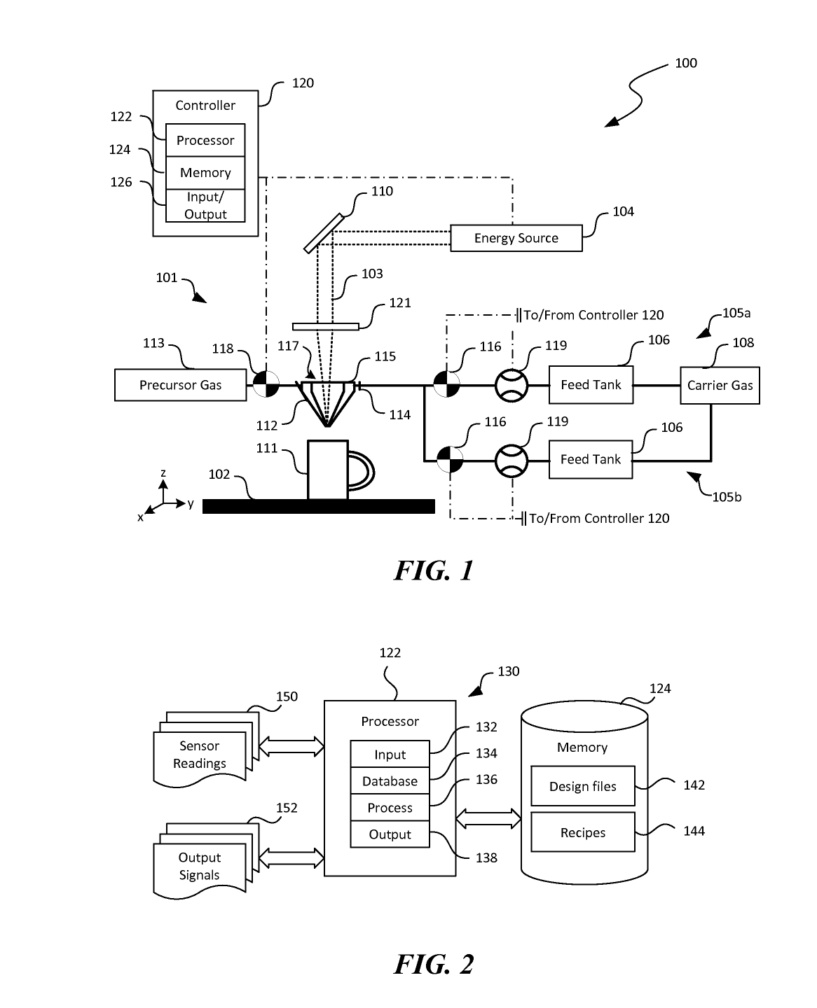

Certain embodiments of systems, devices, articles of manufacture, and processes for reactive deposition are described below. In the following description, specific details of components are included to provide a thorough understanding of certain embodiments of the disclosed technology. A person skilled in the relevant art will also understand that the disclosed technology may have additional embodiments or may be practiced without several of the details of the embodiments described below with reference to FIGS. 1-12.

As used herein, the term “reactive deposition” generally refers to a deposition process in which a precursor material react with another precursor material and/or a substrate material to form a composite material. The formed composite material has a phase different than the precursor material, the another precursor material, and the substrate material. In one example, titanium nitride (TiN) can be formed in a reactive deposition process by introducing precursor nitrogen (N₂) into a deposition environment in which a titanium substrate material is partially melted with an energy stream. In another example, titanium silicon nitride (Ti—Si—N) composite materials can also be formed in a reactive deposition process by introducing silicon (Si) as another precursor material into the deposition environment. Additional examples of such composite materials are also described below. These examples, however, are for illustration purposes only. Several embodiments of the disclosed technology can be applied to form products of other suitable composite materials.

Also used herein, the term “phase” generally refers to a physical state in which a material segment, for example, of the composite material, has a generally homogeneous chemical composition, crystalline structure, or other physical properties. In one example, a substrate having a substrate phase and a composite phase having a composite phase. The substrate phase (e.g., Cp-Ti) can have different chemical composition, crystalline structure, hardness, wear characteristics, or other physical properties than those of the composite phase (e.g., Ti—Si—N, Ti—N, TiC, etc.).

FIG. 1 is a schematic diagram of a reactive deposition system 100 in accordance with embodiments of the disclosed technology. As shown in FIG. 1, the reactive deposition system 100 can include a deposition platform 102, an energy source 104, a first feed line 105a, a second feed line 105b, and a controller 120 operatively coupled to one another. Even though particular components are illustrated in FIG. 1, in other embodiments, the reactive deposition system 100 can also include power supplies, purge gas supplies, and/or other suitable components.

As shown in FIG. 1, the deposition platform 102 can be configured to carry a substrate having a substrate material (e.g., Ti) or a formed product 111 (shown as a cup for illustration purposes). The deposition platform 102 can also be configured to move the deposition platform 102 in x-, y-, and z-axis in a raster scan, continuous scan, or other suitable manners. In certain embodiments, the deposition platform 102 can be coupled to one or more electric motors controlled by a logic processor (not shown) to perform various scanning operations. In other embodiments, the deposition platform 102 can be coupled to pneumatic actuators and/or other suitable types of drives configured to perform the scanning operations.

The energy source 104 can be configured to provide an energy stream 103 into a deposition environment 101. In certain embodiments, the energy source 104 can include an Nd:YAG or any other suitable types of laser capable of delivering sufficient energy to the deposition environment 101. In other embodiments, the energy source 104 can also include microwave, plasma, electron beam, induction heating, resistance heating, or other suitable types of energy sources. In the illustrated embodiment, the reactive deposition system 100 also includes a reflector 110 (e.g., a mirror) and a focusing lens 121 configured to cooperatively direct the energy stream 103 into the deposition environment 101. In other embodiments, the reactive deposition system 100 can also include collimators, filters, and/or other suitable optical and/or mechanical components (not shown) configured to direct and deliver the energy stream 103 into the deposition environment 101.

The first and second feed lines 105a and 105b can be configured to deliver first and second precursor materials (e.g., metallic or ceramic powders) to the deposition environment 101, respectively. In the illustrated embodiment, each feed line 105a and 105b includes a feed tank 106, a valve 116, and a feed rate sensor 119. The feed tanks 106 can individually include a storage enclosure suitable for storing a corresponding precursor material. The valves 116 can each include a gate value, a globe valve, or other suitable types of valves. The feed rate sensor 119 can each include a mass meter, a volume meter, or other suitable types of meter.

In the illustrated embodiment, both the first and second feed lines 105a and 105b are coupled to a carrier gas source 108 containing argon (Ar) or other suitable inert gases. The carrier gas source 108 can be configured to provide sufficient pressure to force the first and second precursor materials from the feed tanks 106 into the deposition environment 101. In other embodiments, each of the first and second feed lines 105a and 105b can include corresponding carrier gas sources (not shown). Even though two feed lines 105a and 105b are shown in FIG. 1 for illustration, in further embodiments, the reactive deposition system 100 can include one, three, four, or any suitable number of feed lines (not shown).

As shown in FIG. 1, the reactive deposition system 100 can also include an optional precursor gas source 113. The precursor gas source 113 can be configured to contain a precursor gas (e.g., nitrogen, oxygen, carbon dioxide, etc.) and provide the precursor gas to the deposition environment 101 via a valve 118. In certain embodiments, the reactive deposition system 100 can include more than one precursor gas source 113 containing different precursor gases. In other embodiments, the precursor gas source 113 may be omitted.

The reactive deposition system 100 can also include a deposition head 112 configured to facilitate aligning the precursor materials from the first and/or second feed lines 105a and 105b with the energy stream 103. The deposition head 112 can include one or more feed ports 114 configured to receive the precursor materials from the first and/or second feed lines 105a and 105b or the optional precursor gas from the precursor gas source 113. The deposition head 114 can also include an opening 117 to receive the energy stream 103. In the illustrated embodiment, the deposition head 112 has a generally conical shape such that precursor materials can be exposed to the energy stream 103 at or near a focal point or plane of the energy stream 103. In other embodiments, the deposition head 112 can have other suitable shapes and/or structures. In further embodiments, the deposition head 112 may be omitted. Instead, the first and second precursor materials may be deposited directly onto the deposition platform 102 at or near a focal point or plane of the energy stream 103.

The controller 120 can include a processor 122 coupled to a memory 124 and an input/output component 126. The processor 122 can include a microprocessor, a field-programmable gate array, and/or other suitable logic devices. The memory 124 can include volatile and/or nonvolatile computer readable media (e.g., ROM; RAM, magnetic disk storage media; optical storage media; flash memory devices, EEPROM, and/or other suitable non-transitory storage media) configured to store data received from, as well as instructions for, the processor 122. In one embodiment, both the data and instructions are stored in one computer readable medium. In other embodiments, the data may be stored in one medium (e.g., RAM), and the instructions may be stored in a different medium (e.g., EEPROM). The input/output component 126 can include a display, a touch screen, a keyboard, a track ball, a gauge or dial, and/or other suitable types of input/output devices.

In certain embodiments, the controller 120 can include a computer operatively coupled to the other components of the reactive deposition system 100 via a hardwire communication link (e.g., a USB link, an Ethernet link, an RS232 link, etc.). In other embodiments, the controller 120 can include a logic processor operatively coupled to the other components of the reactive deposition system 100 via a wireless connection (e.g., a WIFI link, a Bluetooth link, etc.). In further embodiments, the controller 120 can include an application specific integrated circuit, a system-on-chip circuit, a programmable logic controller, and/or other suitable computing frameworks

In operation, the controller 120 can receive a desired design file for a target product or article of manufacture, for example, in the form of a computer aided design (“CAD”) file or other suitable types of file. The design file can also specify at least one of a composition, a crystalline structure, or a desired physical properties for one or more segments of the product. In response, the controller 120 can analyze the design file and generate a recipe having a sequence of operations to form the product via reactive deposition in layer-by-layer, section-by-section, or other suitable accumulative fashion.

For example, in one embodiment, the controller 120 can instruct the first and second feed lines 105a and 105b to provide first and/or second precursor materials at a feed ratio determined based on the design file to the deposition head 112. The controller 120 can also instruct the energy source 104 to provide the energy stream 103 to the deposition head 112 to melt the first and second precursor materials, and thus causing the first and second precursor materials to react and form a composite material having the desired composition, crystalline structure, or physical properties as specified in the design file. In certain embodiments, the first and/or second precursor materials can include elemental metals (e.g., titanium, aluminum, nickel, silver, etc.) to form intermetallic alloys (e.g., TiAl, TiNi, TiAlNi, etc.). In other embodiments, the first and/or second precursor materials can include ceramic materials (e.g., BrN2) that can react with an elemental metal (e.g., Ti) to form high melting point composite materials (e.g., TiBr, TiBr2, TiN, etc.). In further embodiments, the energy stream 103 can cause the first and second precursor materials to react by partially melting or without melting the first and/or second precursor materials.

The controller 120 can then instruct the deposition platform to move the composite material away from the focal point or plane of the energy stream 103 such that the composite material solidifies forming a layer or a portion of the product. In other embodiments, the provided energy stream 103 can also melt a portion of the substrate material (e.g., Ti) of the substrate, thereby causing the substrate material to react with the first and/or second precursor materials to form the composite material. The foregoing operations can then be repeated on the formed layer or portion in, for example, a layer-by-layer manner until the entire product is completed.

In certain embodiments, foregoing deposition operations can be performed in the deposition environment 101 having an inert gas (e.g., argon). The controller 120 can also instruct the valve 118 to open and thus introduce a precursor gas (e.g., nitrogen, oxygen, carbon dioxide, etc.) into the deposition environment 101 when building certain layer or section of the product. The precursor gas can thus at least partially displace the inert gas and react with the first and/or second precursor materials to form a new phase in the product. For example, introducing nitrogen into the deposition environment 101 having a titanium substrate material can form titanium nitride. In another example, introducing carbon dioxide into the deposition environment 101 can form titanium carbide. In other embodiments, the controller 120 can also instruct the energy source 104 to adjust at least one of a laser power or scanning speed based on a desired property for a segment of the product. In further embodiments, the controller 120 can instruct all of the foregoing components of the reactive deposition system 100 in any suitable manners.

Unlike CVD, PVD, or thermal spraying techniques, several embodiments of the reactive deposition system 100 can be more flexible in achieving the desired properties or characteristics for the product. For instance, several embodiments of the reactive deposition system 100 can be flexible in structural, compositional, dimensional, and property control during deposition by dynamically varying, for example, feed rates or feed ratio of the first and/or second precursor materials, by introducing the precursor gas, by adjusting at least one of power or scanning speed of the energy source 104, and/or manipulating other suitable operating parameters.

Due at least in part to such flexibility, several embodiments of the reactive deposition system 100 can efficiently and cost effectively produce products and articles with target profiles of structure, composition, crystallinity, and/or other physical properties, especially high melting point ceramics. For example, in the illustrated embodiment, the product 111 can be formed by depositing layers of the composite material in a sequential manner. During deposition, phases of the deposited composite material can be varied on the same layer or on different layers by adjusting one or more operating parameters of the deposition process when forming the layer(s), such as the feed rate of the first or second precursor material.

As such, the formed product can have the desired shape and dimension with, for example, a target gradient of composition, crystallinity, hardness, wear characteristics, or other physical properties along a length, radius, or other dimensions of the product 111. For instance, the product 111 can include a cylinder having a first cylindrical section with a composition, crystallinity, or other properties different than a second cylindrical section along a length of the cylinder. In another example, the product 111 can include another cylinder having a core section with a composition, crystallinity, or other properties different than a peripheral section along a radius of the cylinder. In a further example, the product 111 can include a cylinder having gradients of composition, crystallinity, or other properties along both the length and radius of the cylinder.

FIG. 2 is a block diagram showing computing system software components 130 suitable for the controller 120 in FIG. 1 in accordance with embodiments of the present technology. Each component may be a computer program, procedure, or process written as source code in a conventional programming language, such as the C++ programming language, or other computer code, and may be presented for execution by the processor 122 of the controller 120. The various implementations of the source code and object byte codes may be stored in the memory 124. The software components 130 of the controller 120 may include an input component 132, a database component 134, a process component 136, and an output component 138.

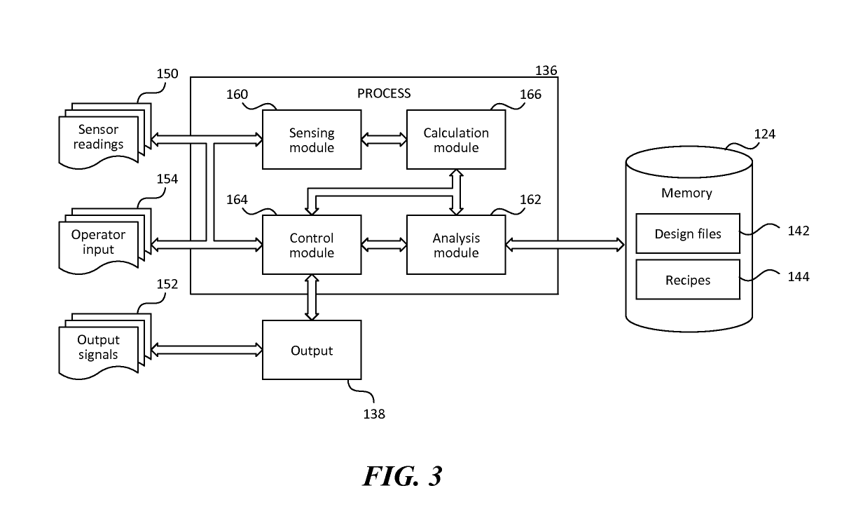

In operation, the input component 132 may accept an operator input, such as a design file for the product in FIG. 1, and communicates the accepted information or selections to other components for further processing. The database component 134 organizes records, including design files 142 and recipes 144 (e.g., steering and/or lane variability), and facilitates storing and retrieving of these records to and from the memory 124. Any type of database organization may be utilized, including a flat file system, hierarchical database, relational database, or distributed database, such as provided by a database vendor such as the Oracle Corporation, Redwood Shores, California. The process component 136 analyzes sensor readings 150 from sensors (e.g., from the feed rate sensors 119) and/or other data sources, and the output component 138 generates output signals 152 based on the analyzed sensor readings 150. Embodiments of the process component 136 are described in more detail below with reference to FIG. 3.

FIG. 3 is a block diagram showing embodiments of the process component 136 of FIG. 2. As shown in FIG. 3, the process component 136 may further include a sensing module 160, an analysis module 162, a control module 164, and a calculation module 166 interconnected with one other. Each module may be a computer program, procedure, or routine written as source code in a conventional programming language, or one or more modules may be hardware modules.

The sensing module 330 is configured to receive and convert the sensor readings 150 into parameters in desired units. For example, the sensing module 160 may receive the sensor readings 150 from the feed rate sensors 119 of FIG. 1 as electrical signals (e.g., a voltage or a current) and convert the electrical signals into a flow rate in engineering units. The sensing module 160 may have routines including, for example, linear interpolation, logarithmic interpolation, data mapping, or other routines to associate the sensor readings 150 to parameters in desired units.

The calculation module 166 may include routines configured to perform various types of calculation to facilitate operation of other modules. For example, the calculation module 166 may include counters, timers, and/or other suitable accumulation routines for deriving a standard deviation, variance, root mean square, and/or other suitable metrics.

The analysis module 162 may be configured to analyze received sensor readings 150 from the sensing module 160 and determine whether the sensor readings 150 are in conformance with the recipe 144. In certain embodiments, the analysis module 162 may indicate that the sensor readings 150 are not in conformance with the recipe 144. As such, the analysis module 162 can indicate to the control module 164 that an adjustment is needed. In other embodiments, the analysis module may indicate that the sensor readings 150 are in conformance with the recipe 144. As such, an adjustment by the control module 164 is not needed.

The control module 164 can be configured to control the operation of the reactive deposition system 100 of FIG. 1 if the sensor readings 150 are not in conformance with the recipe 144. For example, the control module 164 may include a feedback routine (e.g., a proportional-integral or proportional-integral-differential routine) that generates one of the output signals 152 (e.g., a control signal of valve position) to the output module 138. In further example, the control module 164 may perform other suitable control operations to improve and/or maintain a deposition operation based on operator input 154 and/or other suitable input.

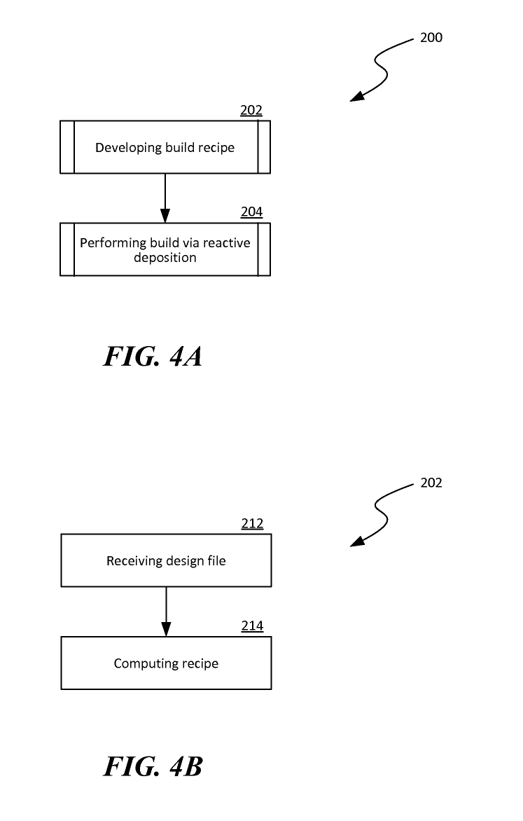

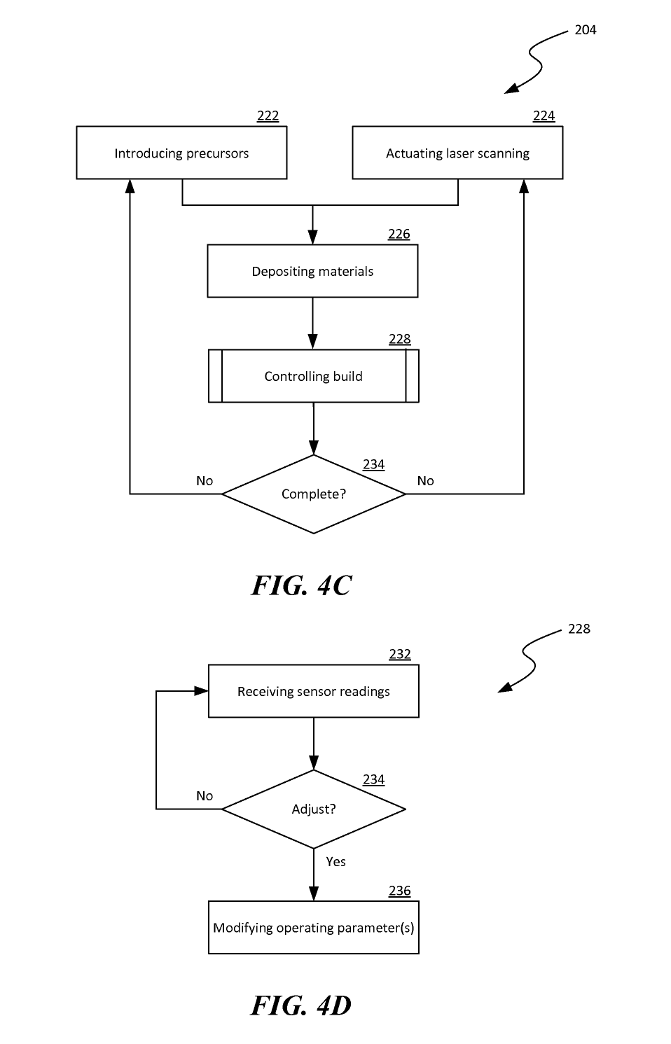

FIG. 4A is a flowchart showing a method 200 for reactive deposition in accordance with embodiments of the present technology. Even though the method 200 is described below with reference to the reactive deposition system 100 of FIG. 1 and the software modules of FIGS. 2 and 3, the method 200 may also be applied in other systems with additional or different hardware and/or software components.

As shown in FIG. 4A, the method 200 includes developing a build recipe at stage 202, for instance, utilizing the controller 120 of FIG. 1. In one embodiment, a build recipe can include a sequence of operations and operating parameters for each operation. Example operating parameters can include feed rates of precursor materials from first and/or second feed lines 105a and 105b, power of the energy source 104, speed and direction of movement of the deposition platform 102, introduction of the precursor gas from the precursor gas source 113, and/or other suitable parameters. In other embodiments, a build recipe can include adjustment of operating parameters of sequential operations or other suitable information. Example operations of developing a build recipe are discussed in more detail below with reference to FIG. 4B.

The method 200 can also include performing a build via reactive deposition based on the developed build recipe at stage 204. For example, in certain embodiments, one or more precursor materials in a determined proportion can be instructed into a deposition environment in which the precursor materials are melted and reacted with one another and/or with a substrate material to form a composite material. The formed composite material can then be allowed to solidify and deposited onto a substrate. The foregoing operations can then be repeated based on the developed build recipe until the product (FIG. 1) is completed. Example operations of performing a build based on the developed recipe are discussed in more detail below with reference to FIG. 4C.

FIG. 4B is a flowchart illustrating a process 202 of developing a build recipe in accordance with embodiments of the disclosed technology. As shown in FIG. 4B, the process 202 can include receiving a design file for the product at stage 212. In one embodiment, the design file can include a CAD file. In other embodiments, the design file can include any suitable types of file specifying a shape, composition, composition variation, dimension, or physical property of the product.

The process 202 can also include computing a recipe based on the received design file at stage 214. In one embodiment, computing the recipe can include constructing a sequence of operations to build the product in a layer-by-layer, section-by-section, or other suitable manners. Each operation sequence in the sequence can be associated with one or more operating parameters discussed above with reference to FIG. 4A.

FIG. 4C is a flowchart illustrating a process 202 of performing a build in accordance with embodiments of the disclosed technology. As shown in FIG. 4C, the process 202 can include introducing one or more precursor materials at stage 222 and actuating laser scanning at stage 224. Even though the operations at stages 222 and 224 are shown as concurrent in FIG. 4C, in other embodiments, these operations may be performed sequentially or in other suitable manners. The process 204 can also include deposition a composite material onto, for example, a substrate or unfinished product at stage 226.

The process 204 can further include controlling the build by varying one or more operating parameters based on the developed recipe at stage 228, as described in more detail below with reference to FIG. 4D. The process 204 can then include a decision stage to determine whether the build is completed. If the product is complete, the process 204 ends; otherwise, the process 204 reverts to introducing precursor materials at stage 222 and actuating laser scanning at stage 224.

FIG. 4D is a flowchart illustrating a process 228 of controlling a build in accordance with embodiments of the disclosed technology. As shown in FIG. 4D, the process 228 can include receiving sensor readings at stage 232. Example sensor readings can be from the feed rate sensors 119 of FIG. 1. The process 228 can then include a decision stage 234 to determine if adjustment is needed based on, for example, a comparison of the received sensor readings and the developed recipe. If adjustment is needed, the process 228 can include modifying the operating parameters at stage 236.

### Experiments

Certain experiments were conducted to form solid structures using a reactive deposition system generally similar to that shown in FIG. 1. Experimental materials, procedures, and results are described in more detail below.

### Processing of Ti—Si—N Composites

Cp-Ti gas atomized powder (Crucible Research, Pittsburgh, Pa., titanium purity 99.998%) with size range 44 to 149 μm and silicon powder (ALDRICH Chemistry, 99% trace metals basis) with size <44 μm were used as starting materials. Powders were mixed using a dry ball mill for 30 min keeping half of the polyethylene bottle filled with zirconia milling media. A LENS™ 750 (Optomec Inc., Albuquerque, N. Mex.) unit was used for processing. The LENS™ chamber was first purged with argon gas to reduce oxygen level to <25 ppm. Nitrogen (99.998% pure) was then introduced into the chamber for about 30 minutes at a pressure of 35 psi.

A 500W continuous wave Nd:YAG laser was used to fabricate Ti—Si—N ceramic coatings on a 2 mm thick Cp-Ti substrate. The Ti—Si premixed powder was delivered on the melt pool through argon-nitrogen carrier gas. At a laser power of 425W, one layer of Ti-xSi (x=0%, 10% and 25% by weight) premix powder was deposited on the Cp-Ti substrate. Square shaped samples were fabricated with sides of 14.5 mm. The raster scanning speed while depositing the powder was 56 cm/min.

All samples were cut using an MTI 150 low speed diamond saw at 470 rpm after processing. Samples were wet ground on silicon carbide grinding paper from 120 to 1000 grits. Final cloth polishing was done to get a mirror finish on the sample surfaces using 1 μm, 0.5 μm and 0.03 μm alumina suspension in deionized water. Samples were then cleaned ultrasonically in 75% ethanol solution for 20 min and finally blow dried. For wear testing, similar grinding and polishing procedure were used. XRD analysis was performed on sample top surfaces using a Siemens D 500 Kristalloflex diffractometer with Cu Kα radiation at 20 kV between the 2θ range of 30° and 65° and a Ni filter. The step size was 0.05°. SEM imaging (FEI Quanta 200F) was done on the cross section of the samples. Samples were etched prior to SEM analysis using Kroll's reagent (92 mL deionized water, 6 mL HNO3 and 2 mL HF).

Hardness tests were performed using a Shimadzu HMV-2T Vickers micro-hardness tester with a load of 1.961 N (HV 0.2) and dwell time of 15s on all samples' cross-sections. At least five sets of standard diamond Vickers indenters were applied on each sample's cross-section. Each set contained five diamond Vickers indenters in different depths. The first diamond Vickers indenter was taken at 50 μm depth and others were taken with a 90 μm depth increment thereon. Additional hardness tests were done at depths of ˜480 μm on the 25% Si sample and at ˜680 μm on the 0% Si sample. Each reported hardness value is an average of the hardness at the same depth.

Linear reciprocating pin-on-disk wear tests were performed on each selected sample coating surface using a Nanovea series tribometer in fully immersed condition in deionized (DI) water medium. Tests were performed at room temperature. Alumina ball (φ=3 mm) was used at a load of 7N and speed of 1200 mm/min. The amplitude of wear track was 10 mm and tests were performed for a distance of 1000 meters for all the samples.

Laser based reactive deposition was performed for 3D printing of in situ Ti—Si—N coatings on Cp-Ti substrates. Amount of Si was varied in the coatings to evaluate its influence on phase formation, hardness and wear resistance of the coatings. FIGS. 5A-5C show example SEM microphotographs of samples in 60-time magnification. 0% Si sample, as seen in FIG. 5a, had the largest coating thickness of 667.8±30.2 μm. 10% Si coating thickness, shown in FIG. 5b, was 264.8±46.9 μm. 25% Si coating, shown in FIG. 5C, was 461.7±62.6 μm. All coatings showed three different zones including (1) in situ reacted ceramic coating; (2) heat affected zone (“HAZ”) and (3) Cp-Ti substrate.

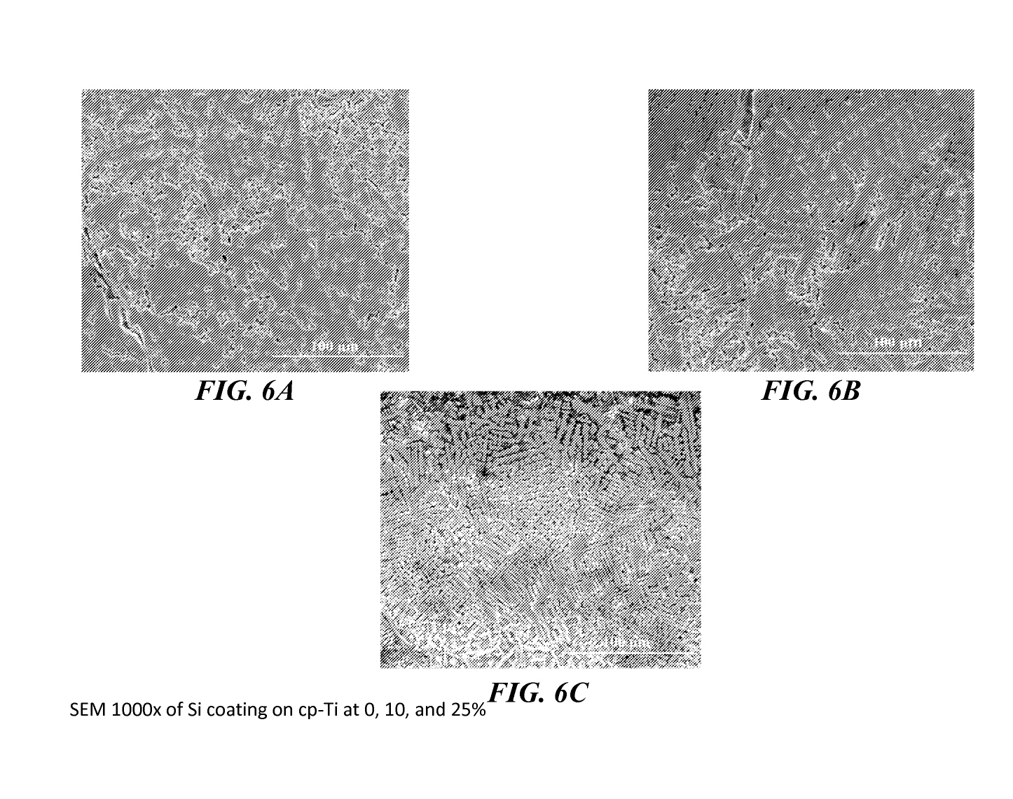

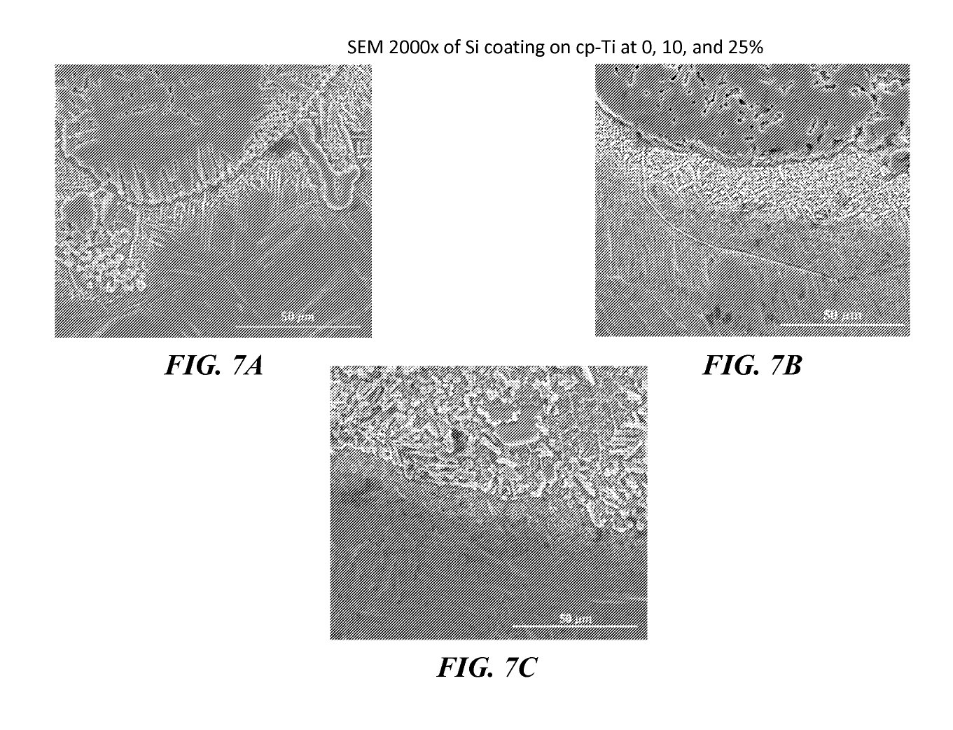

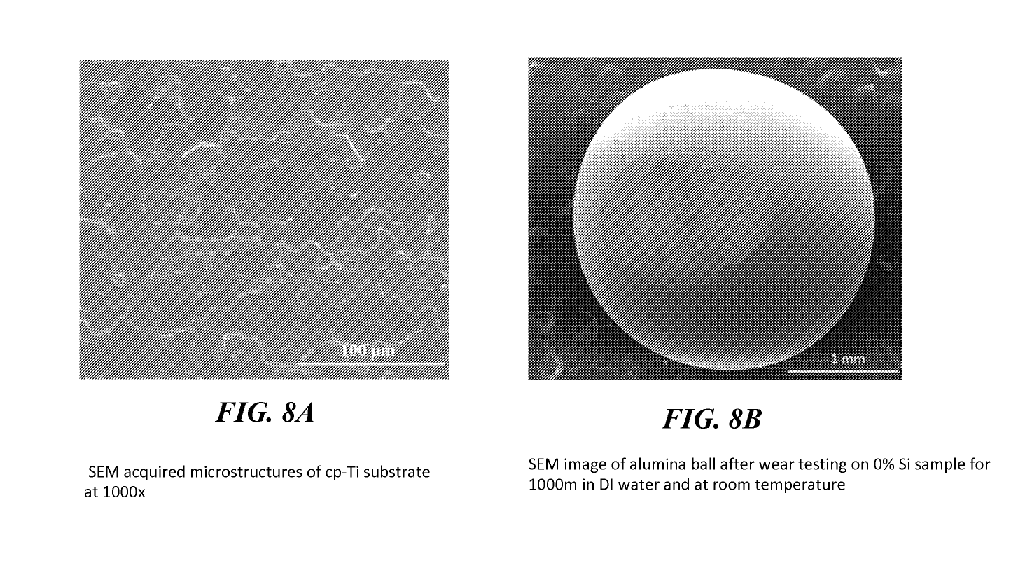

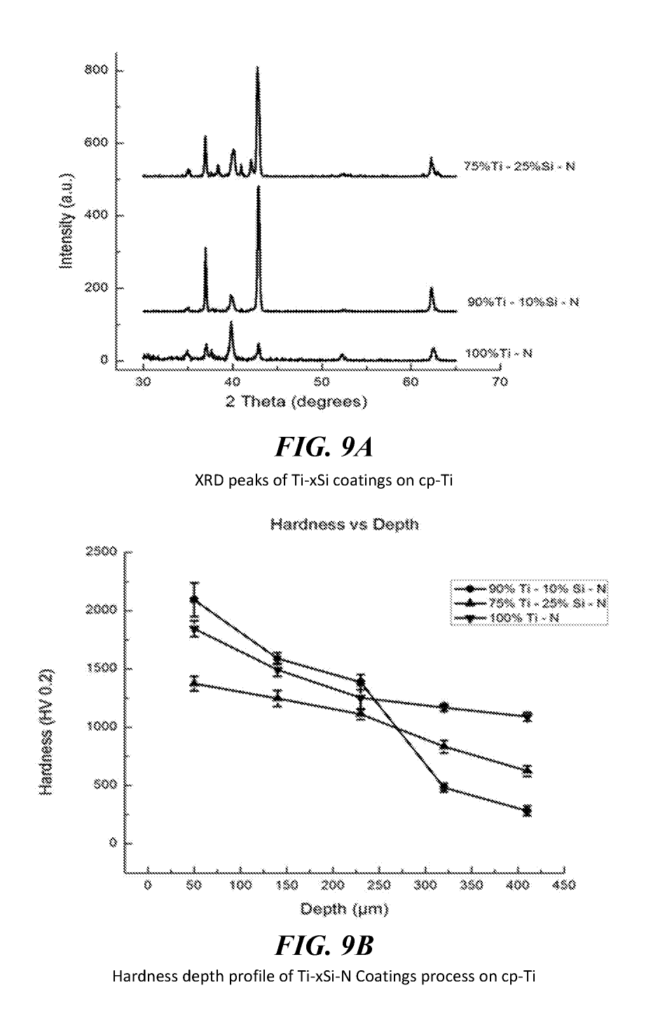

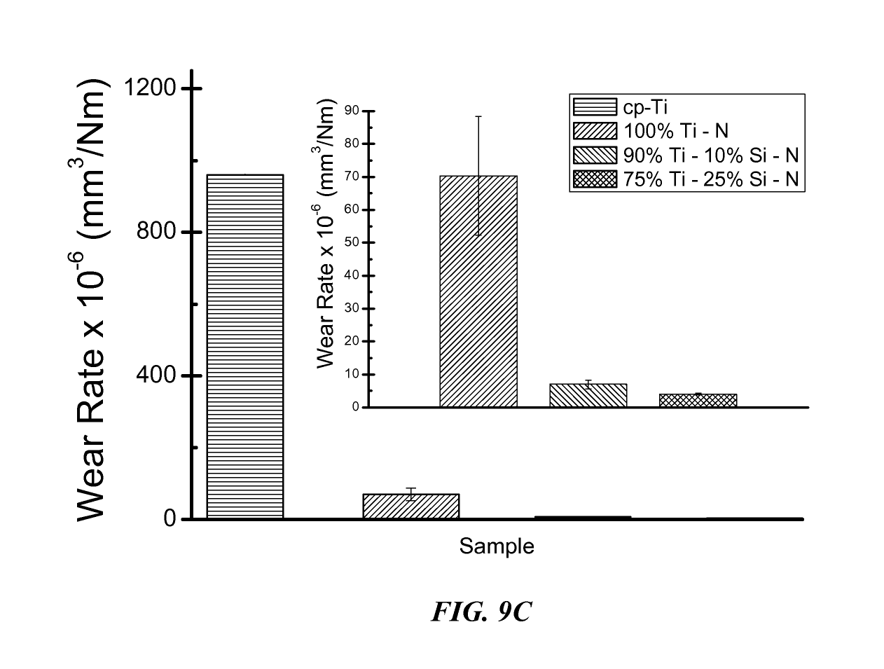

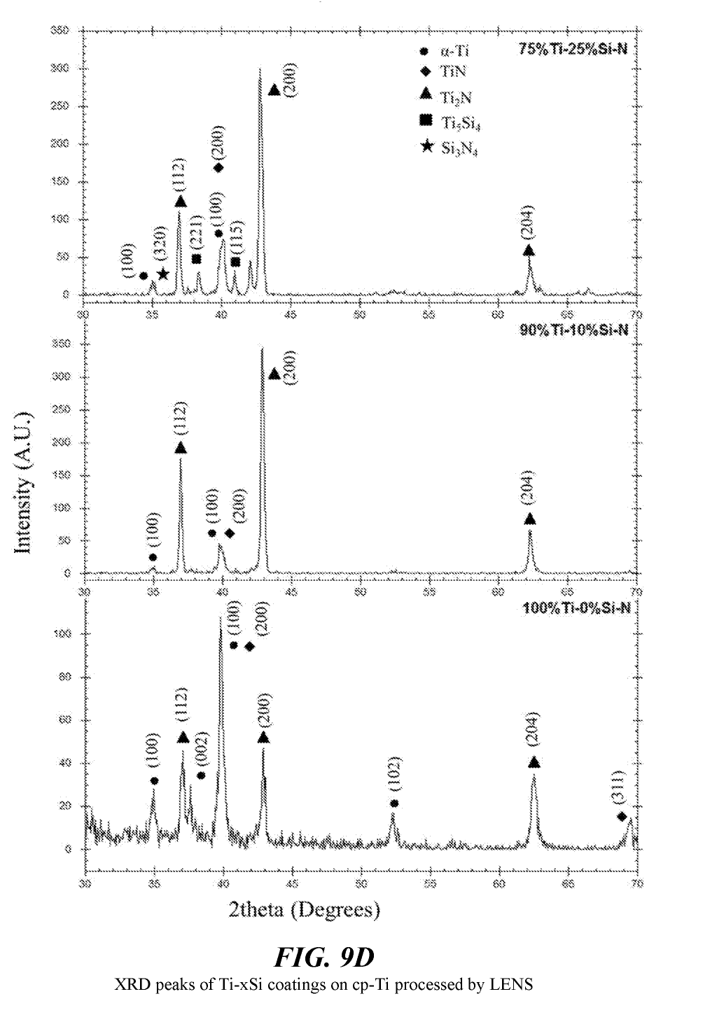

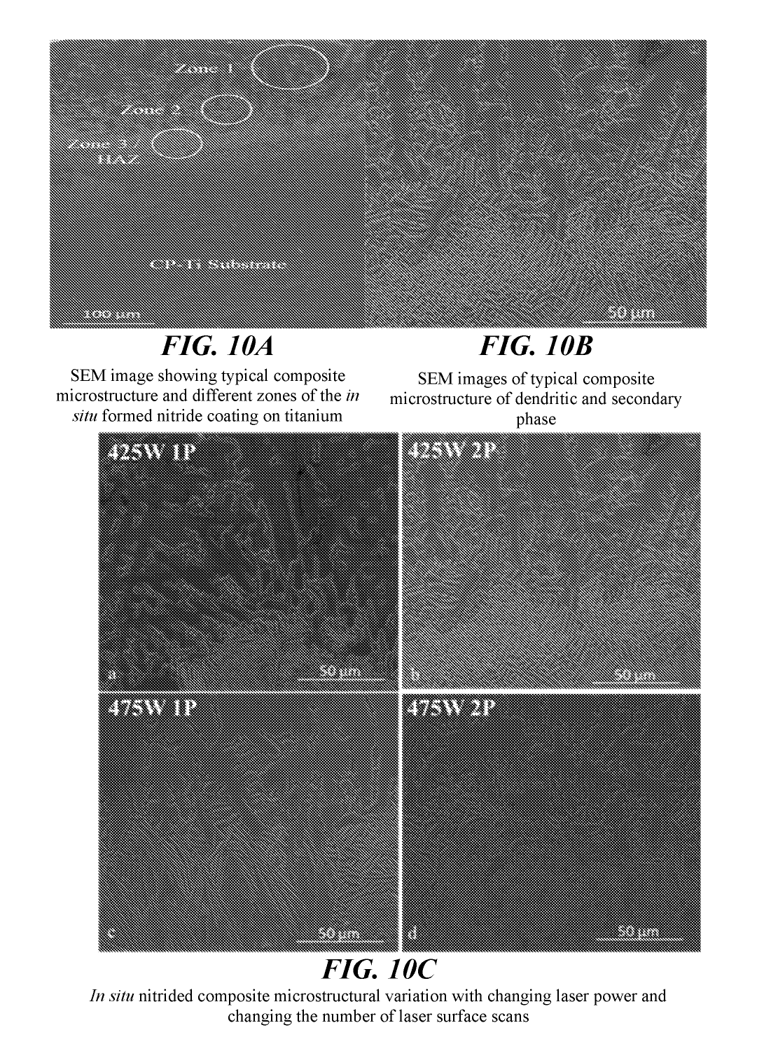

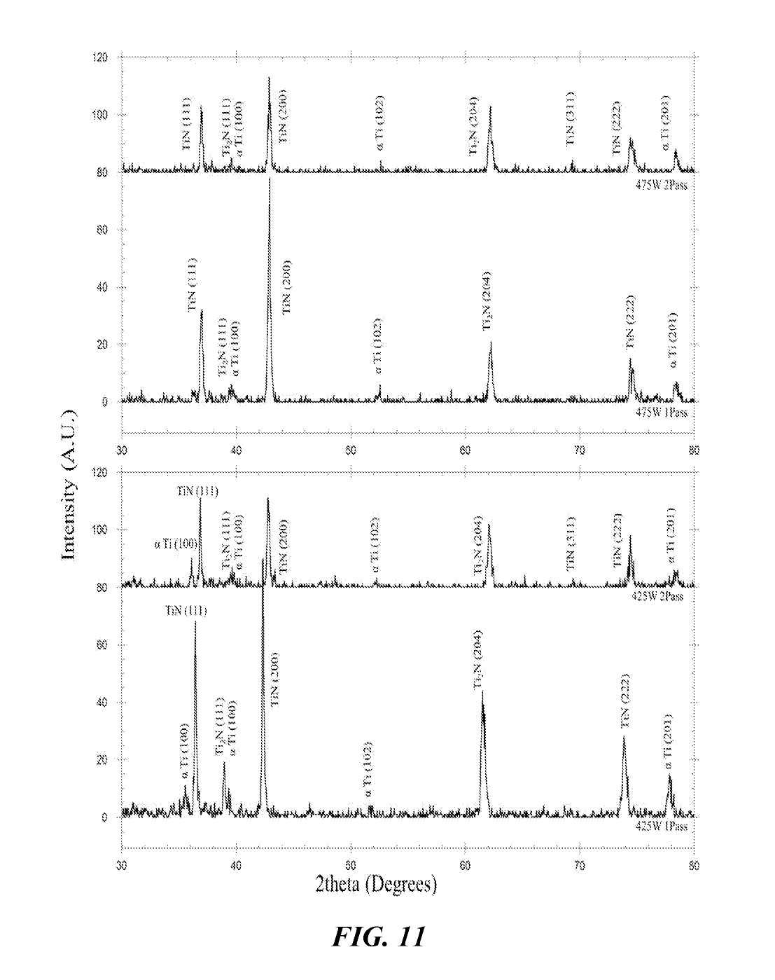

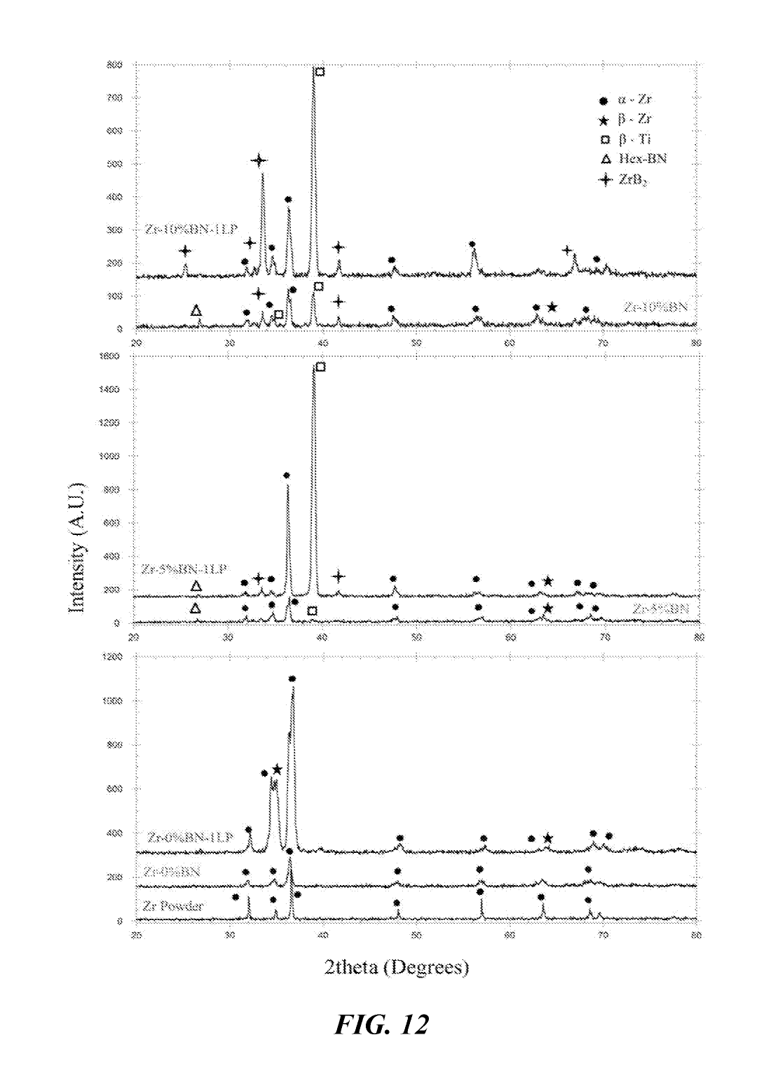

FIGS. 6A-6C show example SEM microphotographs of samples in 1000-time magnification. Dendritic microstructures can be seen in all three samples suggesting a melt-cast reactive formation where presence of Si enhanced dendrite formation. Only a few clear dendrites were found near the surface region in 0% Si sample, and shown in FIG. 6A. Some porosity can also be seen in 0% Si samples. Both 10% Si coating, FIG. 6B, and 25% Si coating, FIG. 6C, show dendritic microstructure throughout the coating. The average length of the primary dendrite for 0% Si sample was 91.22±33.69 μm; while the same for the 10% Si was 71.75±14.13 μm, and 25% Si was 26.71±11.51 μm. As visible from the SEM images and the quantified data, increasing Si content correlated to finer dendrites in the coatings.

FIGS. 7A-7C show example SEM microphotographs of samples in 2000-time magnification. Fine needle-shape structures were found close to the in situ reacted ceramic coating zone. Coarse needle-shape structures, however, were found deeper in sample and tended to grow towards the surface. FIG. 8A is an example SEM image taken at the base metal, Cp-Ti substrate, at 1000-time magnification. Equiaxed grains, typical to Cp-Ti, can be seen away from the coating zone.

XRD patterns for the Ti—Si—N coatings deposited at Cp-Ti substrate are shown in FIG. 9A. Formation of TiN was observed in all samples. The coatings exhibit (111), (200) and (220) orientation. The intensity of these phases was found to reduce with increasing the Si addition to 25% Si. In addition, TiN (200) was the dominant peak in both 10% Si and 25% Si samples. No crystalline silicon nitrides or any phases of titanium silicide were found from 10% Si coating. Si content in 10% Si samples appeared to present in an amorphous state of either Si3N4 or free Si or is fully dissolved in Ti matrix. However, β-Si3N4 was found on 25% Si coating.

The average top surface hardness value for 0% Si sample was 1846±68.5 HV_{0.2.} The average top surface hardness value for 10% Si sample was 2093.67±144 HV_{0.2} and that of 25% Si sample was 1375.3±61.4 HV_{0.2}. Compared with the hardness of the Cp-Ti substrate, which was 85±5 HV_{0.1}, hardness was increased more than 20 times, 24 times, and 15 times, respectively, due to in situ surface nitridation and Si addition.

FIG. 9B shows hardness depth profiles for all three coatings. For both 0% Si and 25% Si samples, hardness showed gradual reduction from depth of 50 μm to 410 μm. The top surface hardness of 0% Si sample was 1846±68.5 HV_{0.2}, this hardness value reduced to 1090.3±38 HV_{0.2} at a depth of 410 μm. 25% Si sample had a hardness value at top surface of 1375.3±61.4 HV_{0.2} and this dropped to 624.3±44 HV_{0.2} at a depth of 410 μm. No steep reductions of hardness were found in both 0% Si and 25% Si samples in the depth of 50 μm to 410 μm region because the thickness of the coatings in these two samples was larger than 410 μm. For 10% Si sample, the hardness value was 2093.67±144 HV_{0.2} at top surface and then gradually dropped to 1386.3±65 HV_{0.2} at a depth of ˜230 μm before sharply dropping to 482.67±32 HV_{0.2} at a depth of 320 μm. A relatively smooth reduction of hardness was obtained from a depth of 320 μm to 410 μm.

Additional hardness tests were performed on both 0% Si and 25% Si samples at HAZ between depths of 480 μm to 680 μm. The results show that hardness of 0% Si sample was 983±36.9 HV_{0.2} at the HAZ and the same for the 25% Si sample was 543.5±21.5 HV_{0.2}. According to FIG. 9B, the hardness of 10% Si sample at HAZ at 270 μm was 1085.2±23.5 HV_{0.2}. This hardness value was similar to the hardness of 0% Si sample at HAZ. However, the hardness of 25% Si sample at HAZ is about 50% lower than the other two samples.

Wear tests were performed as linear reciprocation wear under load at room temperature. Alumina ball (φ=3 mm) was used at a load of 7N. The total wear distance recorded was 1 km and the samples were fully immersed in deionized water throughout the test. The wear rates were reported as an average values for each sample.

Based on the measurements, 0% Si sample had wear track width of 947±82 μm; the same for 10% Si sample was 440±29 μm and 25% Si sample was 370±8 μm. The calculated normalized wear rate for each sample is shown in FIG. 9C. The 0% Si sample had the highest wear rate, which was (70.3784±18.0448)×10−6 mm3/Nm. The wear rate of 10% Si sample was (7.0044±1.3178)×10−6 mm3/Nm. The wear rate for the 25% Si sample was (4.1006±0.2556)×10−6 mm3/Nm. Thus, the wear rates of 10% Si and 25% Si coatings were significantly lower than 0% Si sample. FIG. 9C also illustrates wear rate reduction from fabricated coatings compared to the wear rate of Cp-Ti which was (960.63±0.2567)×10−6 mm3/Nm. Particularly, wear rates were reduced more than 13 times, 130 times, and 240 times for the 0% Si, 10% Si and 25% Si samples, respectively. FIG. 8B shows an example SEM image of the alumina ball after wear testing on 0% Si coating surface and surface damage can be seen on the alumina ball. This damaged volume was calculated to be about 1% of the volume of the ball. The damaged volumes of alumina balls from other two samples were also calculated and the results were similar.

### Processing of Titanium Nitride Composites

Commercially pure titanium plate (3 mm thick and 99.99% pure, President Titanium, Hanson, Mass. USA) was used as substrate material. Samples were fabricated using LENS™ 750 (Optomec Inc. Albuquerque, N. Mex. USA) equipped with a 500 W continuous wave Nd:YAG laser. Operation was generally performed in a glove box containing argon atmosphere and very low level of oxygen (<10 ppm). In the laser surface modification experiments, argon was replaced with nitrogen by purging the chamber with nitrogen gas (99.996% pure) for 25 min at an inlet pressure of 1200 psi. The resultant environment in the glove box contained approximately 75% nitrogen and remainder argon. Oxygen was maintained below 10 ppm and was continuously monitored using an oxygen sensor.

Laser surface nitriding was carried out by raster scanning the Cp-Ti metallic substrate in the nitrogen rich environment. Raster scanning was done at a speed of 56 cm/min. Raster scanning was executed from a CAD design to fabricate square shaped samples with side-length of 14 mm. Samples were made with one and two passes (raster scans on the surface) at both 425W and 475W laser power. While fabricating samples with two raster scans, the second scan was done at 90° angle to the first one to promote homogeneity in re-melting. Samples treated once at 425W is labeled as 425W 1P whereas sample treated twice at 425W is labeled as 425W 2P. Similarly, for 475W 1P is the sample treated once at 475W and 475W 2P is the sample treated twice at 475W.

Before laser treatment, the Cp-Ti plate had a microstructure of equiaxed α-Ti grains. Etched microstructures of surface nitrided Cp-Ti under SEM showed a graded microstructure. There was no sharp interface observed and the microstructure showed gradual change in morphology from dendritic-composite structure at the surface to equiaxed grains of the Cp-Ti substrate inside. FIG. 10A shows an example SEM image of the etched cross section of the Cp-Ti substrate nitrided at 425W with 2 laser scans. The cross section can be divided into three distinct zones—zone 1, zone 2 and zone 3. Zone 1 was the uppermost region of the sample and had a depth of approximately 200 μm with a variation of 50 μm between different samples. This zone includes mostly dendrites that formed after laser re-melting and solidification. These dendrites seemed to be dispersed in a secondary phase. Zone 2 was the layer below the Zone 1. With increasing depth, the dendritic phase appeared to reduce in proportion while more secondary phase was observed. This zone was mostly reduced dendrites with extensive and continuous secondary phase. The secondary phase appeared to be acicular or needle like.

FIG. 10B shows this mixed phase microstructure. Finally in Zone 3, acicular needles from the Zone 2 became more ordered and were seen to grow in the direction of heat flow. This region was mostly comprised of the needle like structures. After the needle like structure ended, there was a region of around 200 μm of finer microstructure which had been affected by the heat of the melt pool above. This was the heat affected zone (HAZ). At a depth of 600 μm and beyond, the original untreated microstructure of Cp-Ti was seen.

The structure of the re-melted and solidified region of the substrate (Zone 1) was dendritic and dispersed in a secondary phase. The laser power used to re-melt the samples as well as the number of laser scans had significant effect on the evolution of microstructure in this region. In the samples that were scanned only once, i.e., samples 425W 1P or 475W 1P, the dendritic phase appeared more continuous. The dendrites were extensive and not all were able to be individually identified. In the case of samples that were scanned twice (samples 425W 2P or 475W 2P), dendrites were smaller, discontinuous and the secondary phase was more dispersed in between the dendrites, as shown in FIG. 10C.

XRD analysis was performed on the surface of the samples showing the formation of different nitrides of titanium upon laser surface melting in a nitrogen rich environment. FIG. 11 shows formation of TiN and Ti2N as well as peaks of the α-Ti phase from the unreacted substrate. The XRD signal was stronger for the samples with two surface scans for both the 425W and 475W power levels. Samples scanned once at 425W (425W 1Pass) showed similar peak intensity as compared to the sample scanned once at 475W (475W 1Pass). The samples scanned twice at 425W and 475W were also similar in terms of peak intensity.

### Processing of Zirconium-Boron Nitride Composites

Zirconium metal powder of purity 99.98% (CERAC Specialty Materials) and particle size of 44 μm to 149 μm was premixed with hexagonal boron nitride powder (Momentive Performance Material) and average particle size of 125 μm. The premixed powders were of three different concentrations by weight: Zr-0% BN, Zr-5% BN and Zr-10% BN. Laser power of 400-475 W was used for the processing of the premised powders, with ideal processing done at 450W. The raster scan speed was constant at ˜80 cm/min and the powder feed rate was kept constant at 16 g/min. The substrate used in the processing of Zr—BN composites was Ti-6AI-4V alloy of 99.999% purity (President Titanium, Hanson, Mass. USA) and thickness of 3 mm. Squared shaped samples were fabricated with side 14.5 mm. For each composition, 8-10 layers were deposited and the deposited samples were ˜0.50 cm thick.

From the deposited samples of each composition, cross sections were cut using a low speed diamond saw (MTI SYJ150 Low Speed Diamond Saw). The cross sectioned samples were then mounted in phenolic resin and wet ground on SiC paper of 120 grit till 1200 grit. After wet grinding, the samples were polished in alumina suspension of 1 μm, 0.30 μm and 0.05 μm. The top most surfaces of the remaining samples were also ground and polished in similar manner. All polished samples were cleaned in an ultrasonic bath with 100% ethanol for 15 minutes and finally blow dried in warm air. Phase analysis of the LENS™ composites was carried out using x-ray diffraction analysis (Siemens D-500 Kristalloflex D5000 Diffractometer, Siemens AG, Karlsruhe, Germany) with Cu Kα radiation. X-ray diffraction was performed at the School of Geological Sciences, University of Idaho, Moscow Id. 83844, USA.

FIG. 12 shows the XRD pattern of Zr—BN composites processed on Ti64 alloy plate. The pattern of the feedstock Zr powder is also shown for reference. As visible from FIG. 12, the feedstock powder was composed entirely of α phase of Zr. Subsequent to reactive deposition processing, the alloy plate retained the a phase as well as cause the retention of some β-Zr phase. In the samples with 5% of BN addition, weak peaks of zirconium diboride (ZrB2) phase were observed along with β-Ti phase. Upon increasing the concentration of BN to 10%, strong ZrB2 phase peaks were observed, thus indicating strong zirconium diboride phase formation. Some unreacted BN (hexagonal) was also observed in both the samples. In all the samples, the corresponding laser passed samples showed strong peaks.

From the foregoing, it will be appreciated that specific embodiments of the disclosure have been described herein for purposes of illustration, but that various modifications may be made without deviating from the disclosure. In addition, many of the elements of one embodiment may be combined with other embodiments in addition to or in lieu of the elements of the other embodiments. Accordingly, the technology is not limited except as by the appended claims.

I/we claim:

1. A method for reactive deposition, comprising:
providing an energy stream into a deposition environment, the provided energy stream having a focal point;
introducing a first precursor material and a second precursor material into the deposition environment at or near the focal point of the provided energy stream, thereby causing the first and second precursor materials to react to form a composite material having a composition different than both the first and second precursor materials; and
allowing the formed composite material to solidify by moving the focal point of the provided energy stream away from the first and second precursor materials.

2. The method of claim 1 wherein:
providing the energy stream includes providing a laser energy stream, a plasma energy stream, an electron beam energy stream, a microwave energy stream, an induction heating energy stream, a resistance heating energy stream, or a combination thereof towards a substrate having a substrate material different than the first and second precursor materials, the provided energy stream melting a portion of the substrate material; and
the first and second precursor materials react with the portion of the substrate material to form the composite material having the composition different than those of the substrate material, the first precursor material, and the second precursor material.

3. The method of claim 2 wherein the composite material is a first composite material that has a first phase different than that of the substrate material, and wherein the method further includes repeating the providing, introducing, and allowing operations on the first composite material to form a second composition material having a phase different than the first phase.

4. The method of claim 2 wherein the composite material is a first composite material that has at least one of a first composition or a first crystalline structure different than that of the substrate material, and wherein the method further includes repeating the providing, introducing, and allowing operations on the first composite material to form a second composition material having at least one of a second composition or a second crystalline structure different than the first composition or the first crystalline structure.

5. The method of claim 1 wherein providing the energy stream includes providing laser energy and adjusting at least one of a power or scanning speed of the provided laser energy based on at a target characteristic of the formed composite material.

6. The method of claim 1 wherein introducing the first precursor material and the second precursor material includes adjusting a feed rate of the first precursor material or the second precursor material based on a target feed ratio between the first precursor material and the second precursor material.

7. The method of claim 1 wherein introducing the first precursor material and the second precursor material includes adjusting a feed rate of the first precursor material or the second precursor material based on a target feed ratio between the first precursor material and the second precursor material, and wherein the target feed ratio varies as a function of time.

8. The method of claim 1 wherein:
providing the energy stream includes providing laser energy into the deposition environment having an inert gas; and
the method further includes introducing a gaseous precursor material into the deposition environment to displace at least a portion of the inert gas, thereby causing at least one of the first or second precursor material to react with the gaseous precursor material to form the composite material.

9. The method of claim 1 wherein the solidified composite material forming a first layer of a target bulk product, and wherein the method further comprising repeating the providing, introducing, and allowing operations on the first layer based on a target design file to form the target bulk product.

10. A reactive deposition system, comprising:
an energy source configured to provide an energy stream into a deposition environment;
a feed line configured to introduce a precursor material into the deposition environment to be at or near the provided energy stream, thereby causing the precursor material and a substrate material of a substrate to react to form a composite material having a composition different than both the precursor material and the substrate material;
a deposition platform configured to carry the substrate and receive the formed composite material, the deposition platform being also configured to allow the formed composite material to solidify by moving the formed composite material away from the focal point of the provided energy stream; and
a controller operatively coupled to the energy source, feed line, and deposition platform, the controller being configured to adjust a feed rate of the precursor material based on a desired phase for the formed composite material.

11. The reactive deposition system of claim 10 wherein:
the feed line is a first feed line;
the precursor material is a first precursor material; and
the reactive deposition system further includes a second feed line configured to introduce a second precursor material into the deposition environment to be at or near the provided energy stream, thereby causing the first and second precursor materials to react with at least a portion of the substrate material to form the composite material different than the substrate material, the first precursor material, and the second precursor material.

12. The reactive deposition system of claim 11 wherein the controller is configured to adjust a feed rate of the first or the second precursor material based on a target composition or crystalline structure of the composite material.

13. The reactive deposition system of claim 10 wherein:
the energy source includes a laser configured to provide laser energy into the deposition environment; and
the controller is configured to adjust at least one of a power or scanning speed of the laser energy of the laser based on at a target characteristic of the formed composite material.

14. The reactive deposition system of claim 10 wherein the controller is configured to adjust a feed rate of the precursor material based on a target composition or crystalline structure of the composite material.

15. The reactive deposition system of claim 10 wherein:
the deposition environment contains an inert gas; and
the reactive deposition system further includes a gas feed line configured to introduce a gaseous precursor material into the deposition environment to displace at least a portion of the inert gas, thereby causing the first and second precursor materials to react with the gaseous precursor material to form the composite material.

16. A controller having a processor and a memory containing instructions that when executed by the processor, cause the processor to perform a process comprising:
(i) instructing an energy source to provide an energy stream into a deposition environment;
(ii) instructing a first feed line and a second feed line to introduce a first precursor material and a second precursor material, respectively, into the deposition environment to react with each other, thereby forming a layer of composite material on a deposition platform, the composite material having a composition different than both the first and second precursor materials;
(ii) instructing the deposition platform to move the formed composite material away from the focal point of the provided energy stream, thereby allowing the formed layer of composite material to solidify;
repeating operations (i), (ii), and (iii) a number of times on the formed layer of composite material to form a plurality of layers as a product; and
during repetitions of operations (i), (ii), and (iii), adjusting one or more operating parameters of operations (i), (ii), and (iii) such that the product having a first portion with a first target composition and a second portion with a second target composition different than the first target composition.

17. The controller of claim 16 wherein adjusting one or more operating parameters includes adjusting a feed rate of the first or second precursor material based on a target phase for the formed composite material.

18. The controller of claim 16 wherein:
the formed composite material is a first composite material having a first phase; and
the process performed by the processor further includes instructing the first or second feed line to adjust a feed rate of the first or second precursor material to form a second composite material having a second phase different than the first phase on the same layer.

19. The controller of claim 16 wherein:
the formed composite material is a first composite material having a first composition and a first crystalline structure; and
the process performed by the processor further includes instructing the first or second feed line to adjust a feed rate of the first or second precursor material to form a second composite material having a second composition and a second crystalline structure different than the first composition or first crystalline structure on the same layer.

20. The controller of claim 16 wherein:
the formed composite material is a first composite material having a first composition and a first crystalline structure; and
the process performed by the processor further includes instructing the first or second feed line to adjust a feed rate of the first or second precursor material to form a second composite material having a second composition and a second crystalline structure different than the first composition and the first crystalline structure on different layers of the product.
